(19) United States
(12) Patent Application Publication
(10) Pub. No.: US 2019/0385172 A1
(43) Pub. Date: Dec. 19, 2019

(54) TRADE FINANCE MANAGEMENT SYSTEMS AND METHODS

(71) Applicant: Baton Systems, Inc., Fremont, CA (US)

(72) Inventors: Arjun Jayaram, Fremont, CA (US); Mohammad Taha Abidi, San Ramon, CA (US); Daniel Craig Mandell, San Anselmo, CA (US)

(21) Appl. No.: 16/395,163

(22) Filed: Apr. 25, 2019

Related U.S. Application Data
(60) Provisional application No. 62/662,747, filed on Apr. 25, 2018.

(51) Int. Cl. G06Q 20/42; G06Q 20/40; G06Q 50/18; G06Q 40/04

(52) U.S. Cl. CPC G06Q 20/425; G06Q 40/04; G06Q 50/188; G06Q 20/405

(57) ABSTRACT

Example trade finance management systems and methods are described. In one implementation, a transaction management system receives information associated with a trade transaction between a seller and a buyer. The transaction management system defines at least one workflow to execute the trade transaction and creates a contract associated with the trade transaction. Further, the transaction management system collects signatures or video evidence that the seller and buyer confirm the contract and verifies the contract.

### RELATED APPLICATIONS

This application claims the priority benefit of U.S. Provisional Application Ser. No. 62/662,747, entitled “Trade Finance Management Systems and Methods,” filed on Apr. 25, 2018, the disclosure of which is hereby incorporated by reference herein in its entirety.

### TECHNICAL FIELD

The present disclosure relates to financial systems and, more particularly, to systems and methods that perform various operations and procedures related to trade finance between two or more entities, individuals, or parties.

### BACKGROUND

Various financial systems are used to transfer assets between different organizations, such as financial institutions. For example, in existing systems, each financial institution maintains a ledger to keep track of accounts at the financial institution and transactions associated with those accounts. Financial institutions generally cannot access the ledger of another financial institution. Thus, a particular financial institution can only see part of a financial transaction (i.e., the part of the transaction associated with that financial institution's accounts). When executing critical asset transfers, it is important that all parties to the transfer can see the details of the transfer. Further, in some situations, it is desirable to provide operations and procedures that support trade finance between multiple entities, individuals, or parties.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram illustrating an environment within which an example embodiment may be implemented.

FIG. 2 is a block diagram illustrating an embodiment of a financial management system configured to communicate with multiple other systems.

FIG. 3 illustrates an embodiment of an example asset transfer between two financial institutions.

FIG. 4 illustrates an embodiment of a method for transferring assets between two financial institutions.

FIG. 5 illustrates an embodiment of a method for authenticating a client and validating a transaction.

FIG. 6 is a block diagram illustrating an embodiment of a financial management system interacting with an API server and an audit server.

FIG. 7 illustrates an embodiment of a transaction for the sale of goods and a trade finance process associated with the transaction.

FIG. 8 illustrates an embodiment of a transaction management system.

FIG. 9 illustrates an embodiment of an example architecture for coordinating a workflow across multiple systems.

FIG. 10 illustrates an embodiment of different states of a shipping process.

FIG. 11 illustrates an embodiment of different types of documentary credit.

FIG. 12 illustrates an embodiment of taxonomy relationships and ontology relationships between different portions of multiple types of documents.

FIG. 13 illustrates an example state diagram showing various states that a transaction may pass through.

FIG. 14 is a block diagram illustrating an embodiment of a financial management system interacting with a cryptographic service and multiple client nodes.

FIG. 15 is a block diagram illustrating an example computing device.

### DETAILED DESCRIPTION

It will be readily understood that the components of the present systems and methods, as generally described and illustrated in the figures herein, could be arranged and designed in a wide variety of different configurations. The following detailed description of the embodiments of the activity management systems and methods is not intended to limit the scope of the invention, as claimed, but is merely representative of certain examples of presently contemplated embodiments in accordance with the invention.

Existing financial institutions typically maintain account information and asset transfer details in a ledger at the financial institution. The ledgers at different financial institutions do not communicate with one another and often use different data storage formats or protocols. Thus, each financial institution can only access its own ledger and cannot see data in another financial institution's ledger, even if the two financial institutions implemented a common asset transfer.

The systems and methods described herein enable institutions to move assets on demand by enabling authorized users to execute complex workflows. Additionally, the described systems and methods allow one or more 3rd parties to view payment activities between participants. Further, the systems and methods support a notary service that uses time stamps and other information to authenticate (or verify) data associated with all parties (e.g., principals) of a transaction, such as a financial transaction.

As used herein, a workflow describes, for example, the sequence of activities associated with a particular transaction, such as an asset transfer. In particular, the systems and methods provide a clearing and settlement gateway between, for example, multiple financial institutions. When a workflow is executed, the system generates and issues clearing and settlement messages (or instructions) to facilitate the movement of assets. A shared permissioned ledger (discussed herein) keeps track of the asset movement and provides visibility to the principals and observers in substantially real time. The integrity of these systems and methods is important because the systems are dealing with core payments that are a critical part of banking operations. Additionally, many asset movements are final and irreversible. Therefore, the authenticity of the request and the accuracy of the instructions are crucial. Further, reconciliation of transactions between multiple parties are important to the management of financial data.

As discussed herein, payments between parties can be performed using multiple asset types, including currencies, treasuries, securities (e.g., notes, bonds, bills, and equities), and the like. Payments can be made for different reasons, such as margin movements, collateral pledging, swaps, delivery, fees, liquidation proceeds, and the like. As discussed herein, each payment may be associated with one or more metadata.

As used herein, DCC refers to a direct clearing client or an individual or institution that owes an obligation. A payee refers to an individual or institution that is owed an obligation. A CCG (or Guarantor) refers to a client clearing guarantor or an institution that guarantees the payment of an obligation. A CCP refers to a central counterparty clearinghouse and a Client is a customer of the FCM (Futures Clearing Merchant)/CCG guarantor. Collateral settlements refer to non-cash based assets that are cleared and settled between CCP, FCM/CCG guarantor, and DCC. CSW refers to collateral substitution workflow, which is a workflow used for the pledging and recall (including substitution) of collateral for cash. A clearing group refers to a logical grouping of stakeholders who are members of that clearing group that are involved in the clearing and settlement of one or more asset types. A workflow, when executed, facilitates a sequence of clearing and settlement instructions between members of a clearing group as specified by the workflow parameters.

When some financial transactions change state (e.g., initiated—pending—approved—cleared—settled, etc.) it may trigger one or more notifications to the principals involved in the transaction. The systems and methods described herein provide multiple ways to receive and respond to these notifications. In some embodiments, these notifications can be viewed and acknowledged using a dashboard associated with the described systems and methods or using one or more APIs.

As used herein, principals refer to the parties that are directly involved in a payment or transaction origination or termination. An observer refers to a party that is not a principal, but may be a stakeholder in a transaction. In some embodiments, an observer can subscribe for a subset of notifications generated by the systems and methods discussed herein. In some situations, one or more principals may need to agree that the observer can receive the subset of notifications. APIs refer to an application program interface that allow other systems and devices to integrate with the systems and methods described herein.

Specific examples discussed herein refer to a financial management system communicating with various systems, financial institutions, authorized systems/devices, data stores, and the like. Although particular examples are discussed with respect to transferring and settling funds between two financial institutions, the same systems and methods may facilitate or manage financial transactions between multiple parties associated with a trade finance situation. For example, the financial management system and methods discussed herein may perform various operations and procedures related to trade finance between two or more entities, individuals, or parties. In some embodiments, the trade finance may be associated with a transaction between a seller and a buyer of goods or services, a transaction between an exporter and an importer, and the like.

The systems and methods described herein use a distributed permissioned ledger (also referred to as a “permissioned ledger”) and smart workflows/contracts in a supply chain and trade finance process to enable real time visibility across multiple participants. With the use of the permissioned ledger, participants only have access to their own data. However, lineage and reconciliation of the whole trade can be achieved by using the distributed permissioned ledger.

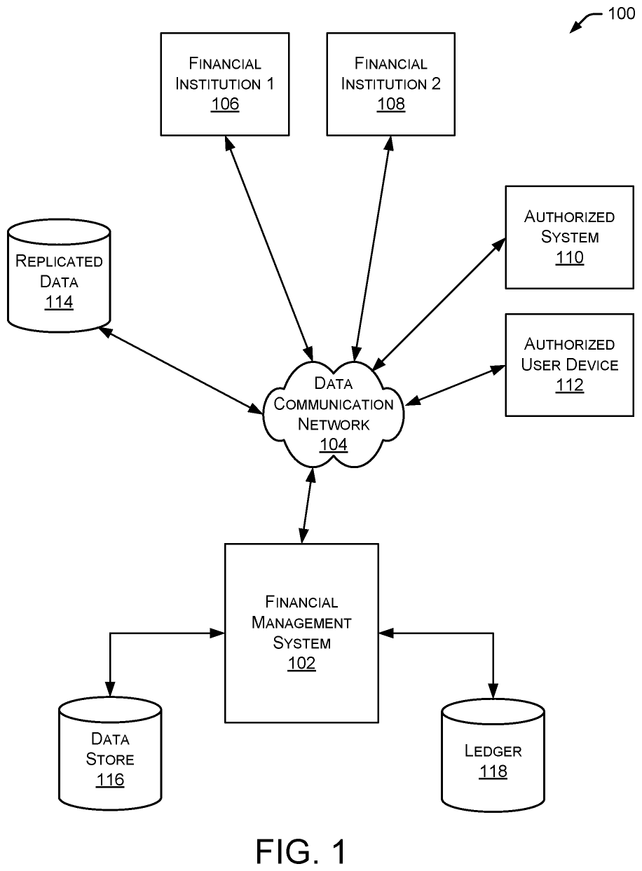

FIG. 1 is a block diagram illustrating an environment 100 within which an example embodiment may be implemented. A financial management system 102 is coupled to a data communication network 104 and communicates with one or more other systems, such as financial institutions 106, 108, an authorized system 110, an authorized user device 112, and a replicated data store 114. As discussed in greater detail herein, financial management system 102 performs a variety of operations, such as facilitating the transfer of assets between multiple financial institutions or other entities, systems, or devices. Although many asset transfers include the use of a central bank to clear and settle the funds, the central bank is not shown in FIG. 1. A central bank provides financial services for a country's government and commercial banking system. In the United States, the central bank is the Federal Reserve Bank. In some implementations, financial management system 102 provides an on-demand gateway integrated into the heterogeneous core ledgers of financial institutions (e.g., banks) to view funds and clear and settle all asset classes. Additionally, financial management system 102 may efficiently settle funds using existing services such as FedWire.

In some embodiments, data communication network 104 includes any type of network, such as a local area network, a wide area network, the Internet, a cellular communication network, or any combination of two or more communication networks. The described systems and methods can use any communication protocol supported by a financial institution's ledger and other systems. For example, the communication protocol may include SWIFT MT (Society for Worldwide Interbank Financial Telecommunication Message Type) messages (such as MT 2XX, 5XX, 9XX), ISO 20022 (a standard for electronic data interchange between financial institutions), and proprietary application interfaces exposed by particular financial institutions. Financial institutions 106, 108 include banks, exchanges, hedge funds, and any other type of financial entity or system. In some embodiments, financial management system 102 interacts with financial institutions 106, 108 using existing APIs and other protocols already being used by financial institutions 106, 108, thereby allowing financial management system 102 to interact with existing financial institutions without significant modification to the financial institution's systems. Authorized system 110 and authorized user device 112 include any type of system, device, or component that is authorized to communicate with financial management system 102. Replicated data store 114 stores any type of data accessible by any number of systems and devices, such as the systems and devices described herein. In some embodiments, replicated data store 114 stores immutable and auditable forms of transaction data between financial institutions. The immutable data cannot be deleted or modified. In particular implementations, replicated data store 114 is an append only data store which keeps track of all intermediate states of the transactions. Additional metadata may be stored along with the transaction data for referencing information available in external systems. In specific embodiments, replicated data store 114 may be contained within a financial institution or other system.

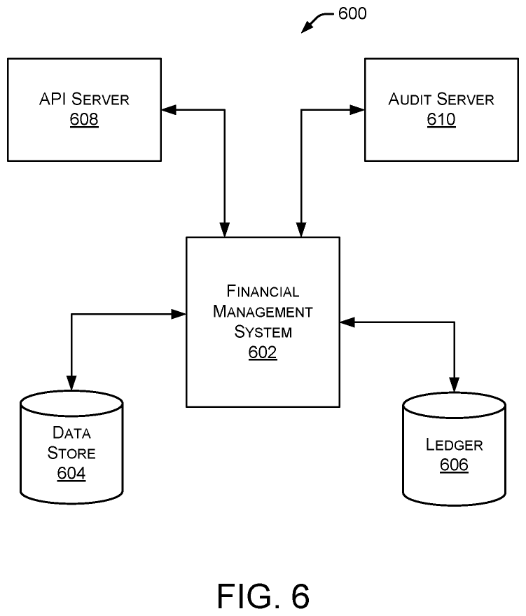

As shown in FIG. 1, financial management system 102 is also coupled to a data store 116 and a ledger 118. In some embodiments, data store 116 is configured to store data used during the operation of financial management system 102. Ledger 118 stores data associated with multiple financial transactions, such as asset transfers between two financial institutions. As discussed herein, ledger 118 is constructed in a manner that tracks when a transaction was initiated and who initiated the transaction. Thus, ledger 118 can track all transactions and generate an audit trail, as discussed herein. Using an audit server of the type described with respect to FIG. 6, financial management system 102 can support audit trails from both the financial management system and external systems and devices. In some embodiments, each transaction entry in ledger 118 records a client identifier, a hash of the transaction, an initiator of the transaction, and a time of the transaction. This data is useful in auditing the transaction data.

In some embodiments, ledger 118 is modeled after double-entry accounting systems where each transaction has two entries (i.e., one entry for each of the principals to the transaction). The entries in ledger 118 include data related to the principal parties to the transaction, a transaction date, a transaction amount, a transaction state, any relevant workflow reference, a transaction ID, and any additional metadata to associate the transactions with one or more external systems. The entries in ledger 118 also include cryptographic hashes to provide tamper resistance and auditability. Users for each of the principals to the transaction only have access to their own entries (i.e., the transactions to which the principal was a party). Access to the entries in ledger 118 can be further restricted or controlled based on a user's role or a party's role, where certain data is only available to certain roles.

In some embodiments, ledger 118 is a shared ledger that can be accessed by multiple financial institutions and other systems and devices. In particular implementations, both parties to a specific transaction can access all details related to that transaction stored in ledger 118. All details related to the transaction include, for example, the parties involved in the transaction, the type of transaction, the date and time of the transaction, the amount of the transaction, and other data associated with the transaction. Additionally, ledger 118 restricts permission to access specific transaction details based on relevant trades associated with a particular party. For example, if a specific party (such as a financial institution or other entity) requests access to data in ledger 118, that party can only access (or view) data associated with transactions to which the party was involved. Thus, a specific party cannot see data associated with transactions that are associated with other parties and do not include the specific party.

The shared permission aspects of ledger 118 provides for a subset of the ledger data to be replicated at various client nodes and other systems. The financial management systems and methods discussed herein allow selective replication of data. Thus, principals, financial institutions, and other entities do not have to hold data for transactions to which they were not a party.

It will be appreciated that the embodiment of FIG. 1 is given by way of example only. Other embodiments may include fewer or additional components without departing from the scope of the disclosure. Additionally, illustrated components may be combined or included within other components without limitation. In some embodiments, financial management system 102 may also be referred to as a “financial management platform,” “financial transaction system,” “financial transaction platform,” “asset management system,” or “asset management platform.”

In some embodiments, financial management system 102 interacts with authorized systems and authorized users. The authorized set of systems and users often reside outside the jurisdiction of financial management system 102. Typically, interactions with these systems and users are performed via secured channels. To ensure the integrity of financial management system 102, various constructs are used to provide system/platform integrity as well as data integrity.

In some embodiments, system/platform integrity is provided by using authorized (e.g., whitelisted) machines and devices, and verifying the identity of each machine using security certificates, cryptographic keys, and the like. In certain implementations, particular API access points are determined to ensure that a specific communication originates from a known enterprise or system. Additionally, the systems and methods described herein maintain a set of authorized users and roles, which may include actual users, systems, devices, or applications that are authorized to interact with financial management system 102. System/platform integrity is also provided through the use of secure channels to communicate between financial management system 102 and external systems. In some embodiments, communication between financial management system 102 and external systems is performed using highly secure TLS (Transport Layer Security) with well-established handshakes between financial management system 102 and the external systems. Particular implementations may use dedicated virtual private clouds (VPCs) for communication between financial management system 102 and any external systems. Dedicated VPCs offer clients the ability to set up their own security and rules for accessing financial management system 102. In some situations, an external system or user may use the DirectConnect network service for better service-level agreements and security.

In some embodiments financial management system 102 allows each client to configure and leverage their own authentication systems. This allows clients to set their custom policies on user identity verification (including 2FA (two factor authentication)) and account verification. An authentication layer in file management system 102 delegates requests to client systems and allows the financial management system to communicate with multiple client authentication mechanisms.

Financial management system 102 also supports role-based access control of workflows and the actions associated with workflows. Example workflows may include Payment vs Payment (PVP) and Delivery vs Payment (DVP) workflows. In some embodiments, users can customize a workflow to add their own custom steps to integrate with external systems that can trigger a change in transaction state or associate them with manual steps. Additionally, system developers can develop custom workflows to support new business processes. In particular implementations, some of the actions performed by a workflow can be manual approvals, a SWIFT message request/response, scheduled or time-based actions, and the like. In some embodiments, roles can be assigned to particular users and access control lists can be applied to roles. An access control list controls access to actions and operations on entities within a network. This approach provides a hierarchical way of assigning privileges to users. A set of roles also includes roles related to replication of data, which allows financial management system 102 to identify what data can be replicated and who is the authorized user to be receiving the data at an external system.

In some embodiments, financial management system 102 detects and records all client metadata, which creates an audit trail for the client metadata. Additionally, one or more rules identify anomalies which may trigger a manual intervention by a user or principal to resolve the issue. Example anomalies include system request patterns that are not expected, such as a high number of failed login attempts, password resets, invalid certificates, volume of requests, excessive timeouts, http errors, and the like. Anomalies may also include data request patterns that are not expected, such as first time use of an account number, significantly larger than normal amount of payments being requested, attempts to move funds from an account just added, and the like. When an anomaly is triggered, financial management system 102 is capable of taking a set of actions. The set of actions may initially be limited to pausing the action, notifying the principals of the anomaly, and only resuming activity upon approval from a principal.

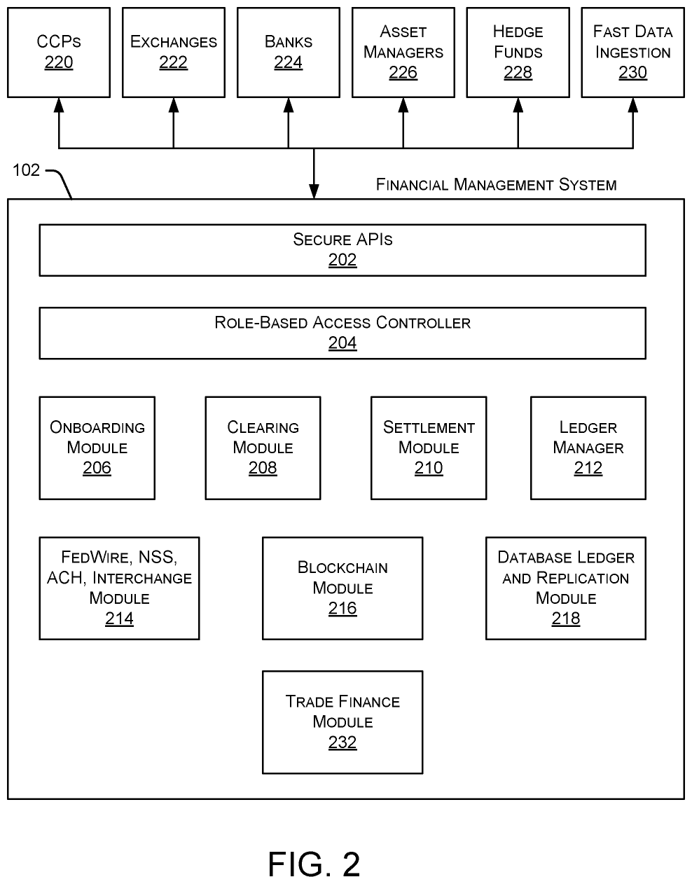

FIG. 2 is a block diagram illustrating an embodiment of financial management system 102 configured to communicate with multiple other systems. As shown in FIG. 2, financial management system 102 may be configured to communicate with one or more CCPs (Central Counterpart Clearing Houses) 220, one or more exchanges 222, one or more banks 224, one or more asset managers 226, one or more hedge funds 228, and one or more fast data ingestion systems (or “pipes”) 230. CCPs 220 are organizations that facilitate trading in various financial markets. Exchanges 222 are marketplaces in which securities, commodities, derivatives, and other financial instruments are traded. Banks 224 include any type of bank, credit union, savings and loan, or other financial institution. Asset managers 226 include asset management organizations, asset management systems, and the like. In addition to hedge funds 228, financial management system 102 may also be configured to communicate with other types of funds, such as mutual funds. Financial management system 102 may communicate with CCPs 220, exchanges 222, banks 224, asset managers 226, and hedge funds 228 using any type of communication network and any communication protocol. Fast data ingestion systems 230 include at least one data ingestion platform that consumes trades in real-time along with associated events and related metadata. The platform is a high throughput pipe which provides an ability to ingest trade data in multiple formats. The trade data are normalized to a canonical format, which is used by downstream engines like matching, netting, real-time counts, and liquidity projections and optimizers. The platform also provides access to information in real-time to different parties of the trade.

Financial management system 102 includes secure APIs 202 that are used by partners to securely communicate with financial management system 102. In some embodiments, the APIs are stateless to allow for automatic scaling and load balancing. Role-based access controller 204 provide access to modules, data and activities based on the roles of an individual user or participant interacting with financial management system 102. In some embodiments, users belong to roles that are given permissions to perform certain actions. An API request may be checked against the role to determine whether the user has proper permissions to perform an action. An onboarding module 206 includes all of the metadata associated with a particular financial institution, such as bank account information, user information, roles, permissions, clearing groups, assets, and supported workflows. A clearing module 208 includes, for example, a service that provides the functionality to transfer assets between accounts within a financial institution. A settlement module 210 monitors and manages the settlement of funds or other types of assets associated with one or more transactions handled by financial management system 102.

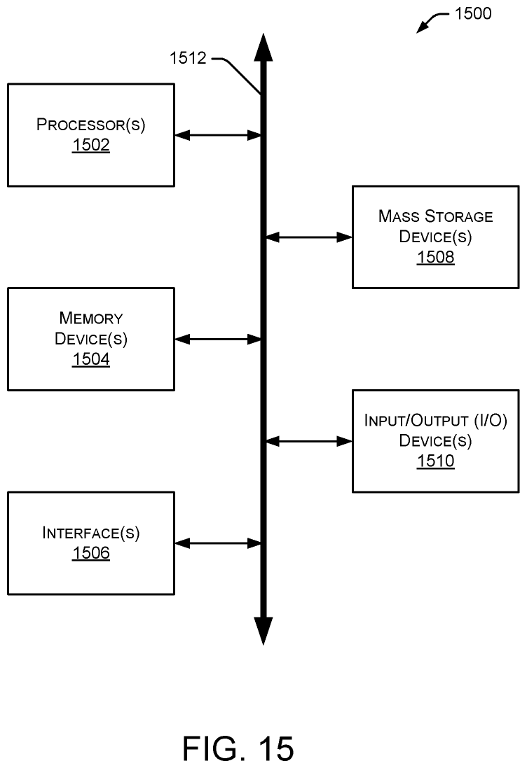

Financial management system 102 also includes a ledger manager 212 that manages a ledger (e.g., ledger 118 in FIG. 1) as discussed herein. A FedWire, NSS (National Settlement Service), ACH (Automated Clearing House), Interchange module 214 provides a service used to interact with standard protocols like FedWire and ACH for the settlement of funds. A blockchain module 216 provides interoperability with blockchains for settlement of assets on a blockchain . A database ledger and replication module 218 provides a service that exposes constructs of a ledger to the financial management system. Database ledger and replication module 218 provides functionality to store immutable transaction states with the ability to audit them. A trade finance module 232 performs various operations and procedures related to trade finance between two or more entities, individuals, or parties. For example, the trade finance operations and procedures may be associated with a transaction between a seller and a buyer of goods or services, a transaction between an exporter and an importer, and the like. Additional details regarding trade finance operations and procedures are discussed herein. The transaction data can also be replicated to authorized nodes for which they are either a principal or an observer. Although particular components are shown in FIG. 2, alternate embodiments of financial management system 102 may contain additional components not shown in FIG. 2, or may not contain some components shown in FIG. 2. Although not illustrated in FIG. 2, financial management system 102 may contain one or more processors, one or more memory devices, and other components such as those discussed herein with respect to FIG. 15.

In the example of FIG. 2, various modules, components, and systems are shown as being part of financial management system 102. For example, financial management system 102 may be implemented, at least in part, as a cloud-based system. In other examples, financial management system 102 is implemented, at least on part, in one or more data centers. In some embodiments, some of these modules, components, and systems may be stored in (and/or executed by) multiple different systems. For example, certain modules, components, and systems may be stored in (and/or executed by) one or more financial institutions.

As mentioned above, system/platform integrity is important to the secure operation of financial management system 102. This integrity is maintained by ensuring that all actions are initiated by authorized users or systems. Additionally, once an action is initiated and the associated data is created, an audit trail of any changes made and other information related to the action is recorded for future reference.

In particular embodiments, financial management system 102 includes (or interacts with) a roles database and an authentication layer. The roles database stores various roles of the type discussed herein.

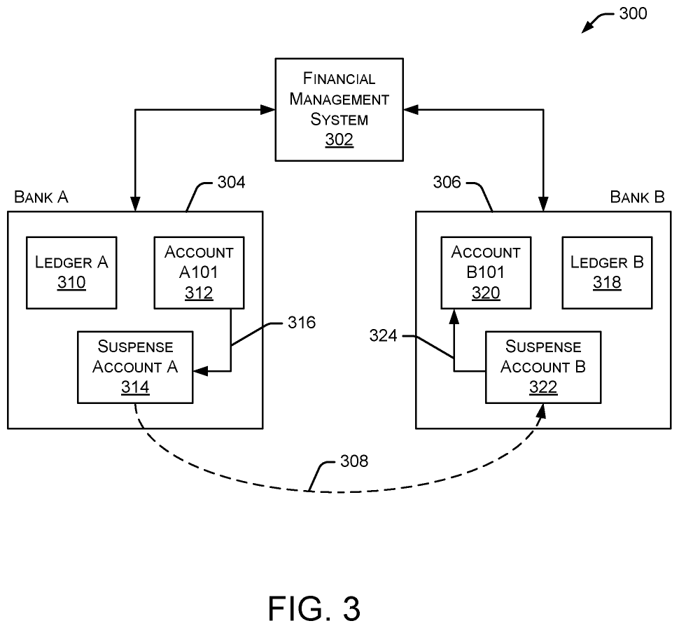

FIG. 3 illustrates an embodiment 300 of an example asset transfer between two financial institutions. In the example of FIG. 3, financial management system 302 is in communication with a first bank 304 and a second bank 306. In this example, funds are being transferred from an account at bank 304 to an account at bank 306, as indicated by broken line 308. Bank 304 maintains a ledger 310 that identifies all transactions and data associated with transactions that involve bank 304. Similarly, bank 306 maintains a ledger 318 that identifies all transactions and data associated with transactions that involve bank 306. In some embodiments, ledgers 310 and 318 (or the data associated with ledgers 310 and 318) reside in financial management system 302 as a shared, permissioned ledger, such as ledger 118 discussed above with respect to FIG. 1.

In the example of FIG. 3, funds are being transferred out of an account 312 at bank 304. To facilitate the transfer of funds out of account 312, the funds being transferred are moved 316 from account 312 to a first suspense account 314 at bank 304. Each suspense account discussed herein is a “For Benefit Of” (FBO) account and is operated by the financial management system for the members of the network (i.e., all parties and principals). The financial management system may facilitate the transfer of assets into and out of the suspense accounts. However, the financial management system does not take ownership of the assets in the suspense accounts. The credits and debits associated with each suspense account are issued by the financial management system and the ledger (e.g., ledger 118 in FIG. 1) is used to track ownership of the funds in the suspense accounts. Each suspense account has associated governance rules that define how the suspense account operates. At bank 306, the transferred funds are received by a second suspense account 322. The funds are moved 324 from second suspense account 322 to an account 320 at bank 306. In some embodiments, a suspense account may be referred to as a settlement account.

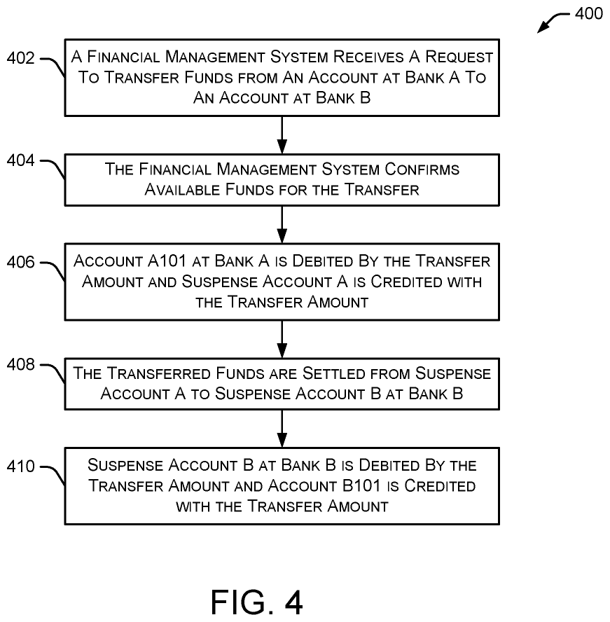

As discussed herein, financial management system 302 facilitates the transfer of funds between bank 304 and 306. Additional details regarding the manner in which the funds are transferred are provided below with respect to FIG. 4. Although only one account and one suspense account is shown for each bank in FIG. 3, particular embodiments of bank 304 and 306 may contain any number of accounts and suspense accounts. Additionally, bank 304 and 306 may contain any number of ledgers and other systems. In some embodiments, each suspense account 314, 322 is established as part of the financial institution “onboarding” process with the financial management system. For example, the financial management system administrators may work with financial institutions to establish suspense accounts that can interact with the financial management system as described herein.

In some embodiments, one or more components discussed herein are contained in a traditional infrastructure of a bank or other financial institution. For example, an HSM (Hardware Security Module) in a bank may execute software or contain hardware components that interact with a financial management system to facilitate the various methods and systems discussed herein. In some embodiments, the HSM provides security signatures and other authentication mechanisms to authenticate participants of a transaction.

FIG. 4 illustrates an embodiment of a method 400 for transferring assets (e.g., funds) between two financial institutions. Initially, a financial management system receives 402 a request to transfer funds from an account at Bank A to an account at Bank B. The request may be received by Bank A, Bank B, or another financial institution, system, device, and the like. Using the example of FIG. 3, financial management system 302 receives a request to transfer funds from account 312 at bank 304 to account 320 at bank 306.

Method 400 continues as the financial management system confirms 404 available funds for the transfer. For example, financial management system 302 in FIG. 3 may confirm that account 312 at bank 304 contains sufficient funds to satisfy the amount of funds defined in the received transfer request. In some embodiments, if available funds are confirmed at 404, the financial management system creates suspense account A at Bank A and creates suspense account B at Bank B. In particular implementations, suspense account A and suspense account B are temporary suspense accounts created for a particular transfer of funds. In other implementations, suspense account A and suspense account B are temporary suspense accounts but are used for a period of time (or for a number of transactions) to support transfers between bank A and bank B.

If available funds are confirmed at 404, then account A101 at Bank A is debited 406 by the transfer amount and suspense account A (at Bank A) is credited with the transfer amount. Using the example of FIG. 3, financial management system 302 debits the transfer amount from account 312 and credits that transfer amount to suspense account 314. In some embodiments, ownership of the transferred assets changes as soon as the transfer amount is credited to suspense account 314.

The transferred funds are then settled 408 from suspense account A (at Bank A) to suspense account B (at Bank B). For example, financial management system 302 in FIG. 3 may settle funds from suspense account 314 in bank 304 to suspense account 322 in bank 306. The settlement of funds between two suspense accounts is determined by the counterparty rules set up between the two financial institutions involved in the transfer of funds. For example, a counterparty may choose to settle at the top of the hour or at a certain threshold to manage risk exposure. The settlement process may be determined by the asset type, the financial institution pair, and/or the type of transaction. In some embodiments, transactions can be configured to settle in gross or net. For gross transaction settlement of a PVP workflow, the settlement occurs instantaneously over existing protocols supported by financial institutions, such as FedWire, NSS, and the like. Netted transactions may also settle over existing protocols based on counterparty and netting rules. In some embodiments, the funds are settled after each funds transfer. In other embodiments, the funds are settled periodically, such as once an hour or once a day. Thus, rather than settling the two suspense accounts after each funds transfer between two financial institutions, the suspense accounts are settled after multiple transfers that occur over a period of time. Alternatively, some embodiments settle the two suspense accounts when the amount due to one financial institution exceeds a threshold value.

Method 400 continues as suspense account B (at Bank B) is debited 410 by the transfer amount and account B101 at Bank B is credited with the transfer amount. For example, financial management system 302 in FIG. 3 may debit suspense account 322 and credit account 320. After finishing step 410, the funds transfer from account 312 at bank 304 to account 320 at bank 306 is complete.

In some embodiments, the financial management system facilitates (or initiates) the debit, credit, and settlement activities (as discussed with respect to FIG. 4) by sending appropriate instructions to Bank A and/or Bank B. The appropriate bank then performs the instructions to implement at least a portion of method 400. The example of method 400 can be performed with any type of asset. In some embodiments, the asset transfer is a transfer of funds using one or more traditional currencies, such as U.S. Dollars (USD) or Great British Pounds (GBP).

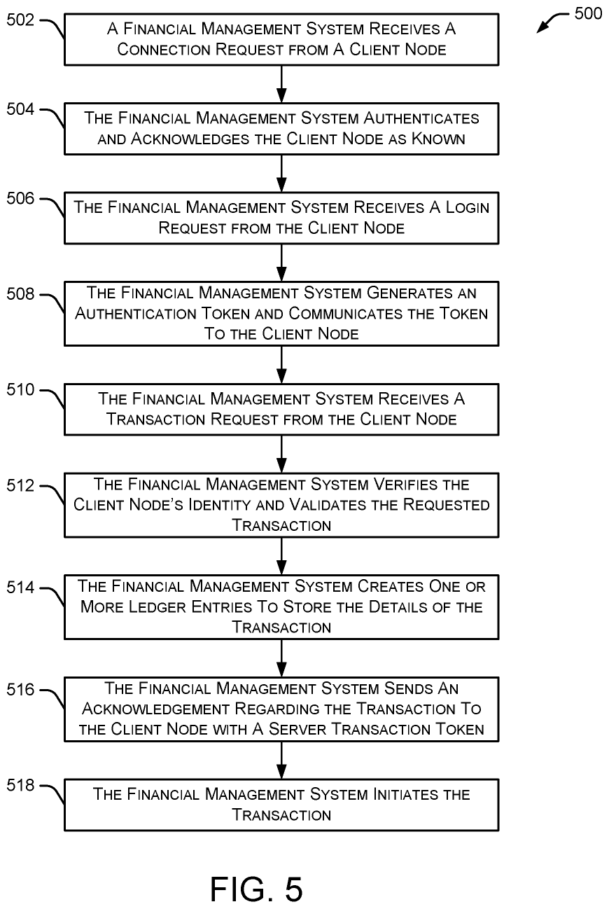

FIG. 5 illustrates an embodiment of a method 500 for authenticating a client and validating a transaction. Initially, a financial management system receives 502 a connection request from a client node, such as a financial institution, an authorized system, an authorized user device, or other client types mentioned herein. The financial management system authenticates 504 and, if authenticated, acknowledges the client node as known. Method 500 continues as the financial management system receives 506 a login request from the client node. In response to the login request, the financial management system generates 508 an authentication token and communicates the authentication token to the client node. In some embodiments, the authentication token is used to determine the identity of the user for future requests, such as fund transfer requests. The identity is then further checked for permissions to the various services or actions.

The financial management system further receives 510 a transaction request from the client node, such as a request to transfer assets between two financial institutions or other entities. In response to the received transaction request, the financial management system verifies 512 the client node's identity and validates the requested transaction. In some embodiments, the client node's identity is validated based on an authentication token, and then permissions are checked to determine if the user has permissions to perform a particular action or transaction. Transfers of assets also involve validating approval of an account by multiple roles to avoid compromising the network. If the client node's identity and requested transaction are verified, the financial management system creates 514 one or more ledger entries to store the details of the transaction. The ledger entries may be stored in a ledger such as ledger 118 discussed herein. The financial management system then sends 516 an acknowledgement regarding the transaction to the client node with a server transaction token. In some embodiments, the server transaction token is used at a future time by the client when conducting audits. Finally, the financial management system initiates 518 the transaction using, for example, the systems and methods discussed herein.

In some embodiments, various constructs are used to ensure data integrity. For example, cryptographic safeguards allow a transaction to span 1-n principals. The financial management system ensures that no other users (other than the principals who are parties to the transaction) can view data in transit. Additionally, no other user should have visibility into the data as it traverses the various channels. In some embodiments, there is a confirmation that a transaction was received completely and correctly. The financial management system also handles failure scenarios, such as loss of connectivity in the middle of the transaction. Any data transmitted to a system or device should be explicitly authorized such that each entry (e.g., ledger entry) can only be seen and read by the principals who were a party to the transaction. Additionally, principals can give permission to regulators and other individuals to view the data selectively.

Cryptographic safeguards are used to detect data tampering in the financial management system and any other systems or devices. Data written to the ledger and any replicated data may be protected by:
Stapling all the events associated with a single transaction.
Providing logical connections of each commit to those that came before it are made.
The logical connections are also immutable but principals can send messages for relinking. In this case, the current and all preceding links are maintained. For example, trade amendments are quite common. A trade amendment needs to be connected to the original trade. For forensic analysis, a bank may wish to identify all trades by a particular trader. Query characteristics will be graphs, time series, and RDBMS (Relational Database Management System).

In some embodiments, the financial management system monitors for data tampering. If the data store (central data store or replicated data store) is compromised in any way and the data is altered, the financial management system should be able to detect exactly what changed. Specifically, the financial management system should guarantee all participants on the network that their data has not been compromised or changed. Information associated with changes are made available via events such that the events can be sent to principals via messaging or available to view on, for example, a user interface. Regarding data forensics, the financial management system is able to determine that the previous value of an attribute was X, it is now Y and it was changed at time T, by a person A. If a system is hacked or compromised, there may be any number of changes to attribute X and all of those changes are captured by the financial management system, which makes the tampering evident.

In particular embodiments, the financial management system leverages the best security practices for SaaS (Software as a Service) platforms to provide cryptographic safeguards for ensuring integrity of the data. For ensuring data integrity, the handshake between the client and an API server (discussed with respect to FIG. 6) establish a mechanism which allows both the client and the server to verify the authenticity of transactions independently. Additionally, the handshake provides a mechanism for both the client and the server to agree on a state of the ledger. If a disagreement occurs, the ledger can be queried to determine the source of the conflict.

FIG. 6 is a block diagram illustrating an embodiment 600 of a financial management system 602 interacting with an API server 608 and an audit server 610. Financial management system 602 also interacts with a data store 604 and a ledger 606. In some embodiments, data store 604 and ledger 606 are similar to data store 116 and ledger 118 discussed herein with respect to FIG. 1. In particular implementations, API server 608 exposes functionality of financial management system 602, such as APIs that provide reports of transactions and APIs that allow for administration of nodes and counterparties. Audit server 610 periodically polls the ledger to check for data tampering of ledger entries. This check of the ledger is based on, for example, cryptographic hashes and are used to monitor data tampering as described herein.

In some embodiments, all interactions with financial management system 602 or the API server are secured with TLS. API server 608 and audit server 610 may communicate with financial management system 602 using any type of data communication link or data communication network, such as a local area network or the Internet. Although API server 608 and audit server 610 are shown in FIG. 6 as separate components, in some embodiments, API server 608 and/or audit server 610 may be incorporated into financial management system 602. In particular implementations, a single server may perform the functions of API server 608 and audit server 610.

In some embodiments, at startup, a client sends a few checksums it has sent and transaction IDs to API server 608, which can verify the checksums and transaction IDs, and take additional traffic from the client upon verification. In the case of a new client, mutually agreed upon seed data is used at startup. A client request may be accompanied by a client signature and, in some cases, a previous signature sent by the server. The server verifies the client request and the previous server signature to acknowledge the client request. The client persists the last server signature and a random set of server hashes for auditing. Both client and server signatures are saved with requests to help quickly audit correctness of the financial management system ledger. The block size of transactions contained in the request may be determined by the client. A client SDK (Software Development Kit) assists with the client server handshake and embedding on server side signatures. The SDK also persists a configurable amount of server signatures to help with restart and for random audits. Clients can also set appropriate block size for requests depending on their transaction rates. The embedding of previous server signatures in the current client block provides a way to chain requests and provide an easy mechanism to detect tampering. In addition to a client-side signature, the requests are encrypted using standard public key cryptography to provide additional defense against client impersonation. API server 608 logs all encrypted requests from the client. The encrypted requests are used, for example, during data forensics to resolve any disputes.

In particular implementations, a client may communicate a combination of a previous checksum, a current transaction, and a hash of the current transaction to the financial management system. Upon receipt of the information, the financial management system checks the previous checksum and computes a new checksum, and stores the client hash, the current transaction, and the current checksum in a storage device, such as data store 604. The checksum history and hash (discussed herein) protect the integrity of the data. Any modification to an existing row in the ledger cannot be made easily because it would be detected by mismatched checksums in the historical data, thereby making it difficult to alter the data.

The integrity of financial management system 602 is ensured by having server audits at regular intervals. Since financial management system 602 uses chained signatures per client at the financial management system, it ensures that an administrator of financial management system 602 cannot delete or update any entries without making the ledger tamper evident. In some embodiments, the auditing is done at two levels: a minimal level which the SDK enforces using a randomly selected set of server signatures to perform an audit check; and a more thorough audit check run at less frequent intervals to ensure that the data is correct.

In some implementations, financial management system 602 allows for the selective replication of data. This approach allows principals or banks to only hold data for transactions they were a party to, while avoiding storage of other data related to transactions in which they were not involved. Additionally, financial management system 602 does not require clients to maintain a copy of the data associated with their transactions. Clients can request the data to be replicated to them at any time. Clients can verify the authenticity of the data by using the replicated data and comparing the signature the client sent to the financial management system with the request.

In some embodiments, a notarial system is used to maintain auditability and forensics for the core systems. Rather than relying on a single notary hosted by the financial management system, particular embodiments allow the notarial system to be installed and executed on any system that interacts with the financial management system (e.g., financial institutions or clients that facilitate transactions initiated by the financial management system).

The systems and methods discussed herein support different asset classes. Each asset class may have a supporting set of metadata characteristics that are distinct. Additionally, the requests and data may be communicated through multiple “hops” between the originating system and the financial management system. During these hops, data may be augmented (e.g., adding trade positions, account details, and the like) or changed.

In certain types of transactions, such as cash transactions, the financial management system streamlines the workflow by supporting rich metadata accompanying each cash transfer. This rich metadata helps banks tie back cash movements to trades, accounts, and clients.

As discussed herein, the described systems and methods facilitate the movement of assets between principals (also referred to as “participants”). The participants are typically large financial institutions in capital markets that trade multiple financial products. Trades in capital markets can be complex and involve large asset movements (also referred to as “settlements”). The systems and methods described herein can integrate to financial institutions and central settlement authorities such as the US Federal Reserve or DTCC (Depository Trust & Clearing Corporation) to facilitate the final settlement of assets. The described systems and methods also have the ability to execute workflows such as DVP, threshold based settlement, or time-based settlement between participants. Using the workflows, transactions are settled in gross or net amounts.

The systems and methods described herein include a platform and workflow to support and enable 3rd party guarantors the ability to view payment activity between participants in real time (or substantially real time), and step in to make payments on behalf of participants when necessary.

As mentioned above, the systems and methods discussed herein may perform various operations and procedures related to trade finance between two or more entities, individuals, or parties. For example, the trade finance operations and procedures may be associated with a transaction between a seller and a buyer of goods or services, a transaction between an exporter and an importer, and the like.

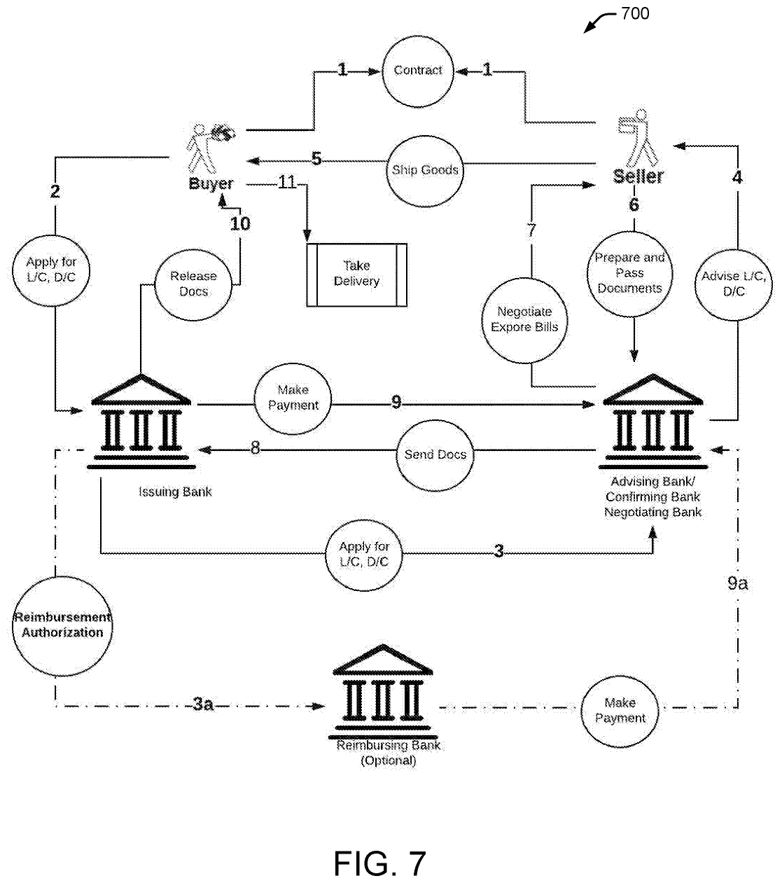

FIG. 7 is a block diagram illustrating an environment 700 associated with a transaction for the sale of goods and a trade finance process associated with the transaction. As shown in FIG. 7, a seller (e.g., an exporter) and a buyer (e.g., an importer) want to enter into a transaction for the exchange of goods and/or services. In some embodiments, the seller and buyer are in different countries, which may cause concern to the seller and buyer regarding payment and receipt of goods or services. For example, a seller may be concerned about getting paid for the goods/services and doesn't want to ship the goods (or provide the services) until they are certain to be paid. Similarly, a buyer may be concerned about receiving the goods/services and doesn't want to release the payment for the goods/services until they are certain to receive the goods/services. The systems and methods discussed herein help alleviate these concerns and ensure that the seller gets paid while the buyer receives the purchased goods/services. In existing systems, multiple banks act as intermediaries to be sure the seller gets paid and the buyer receives the goods/services. However, as described below, these existing systems are primarily manual operations that are implemented using paper contracts. This existing approach is inefficient and requires significant human interaction to process all of the necessary steps.

As shown in FIG. 7, a transaction may be controlled by a contract, where the contract defines multiple parameters and other details associated with the transaction. Typically, the contract is negotiated between the buyer and seller. When the contract is finalized, the buyer and seller contact one or more banks to help with the execution of the transaction. In some embodiments, the contract includes information associated with pricing terms, timing of payments, timing of delivery, type of goods, quantity and quality of goods, shipping terms, insurance coverage requirements, which party (e.g., buyer or seller) assumes risks at different points in the transaction (e.g., during shipment of the goods), and the like. In many situations, one or more banks (e.g., the issuing bank and/or the advising bank shown in FIG. 7) define at least a portion of the terms of the transaction, such as the requirements for releasing funds from the buyer to the seller, and releasing ownership of the goods from the seller to the buyer. Different banks may require different terms and processes when processing a transaction.

The first step (step #1 in FIG. 7) includes the buyer and seller negotiating a contract for the sale of goods/services. After the contract is finalized, the buyer sends the contract to the issuing bank and applies for a line of credit (or letter of credit) “L/C” (step #2 in FIG. 7). In some embodiments, the application for a L/C is a request from the buyer for the issuing bank to provide a line of credit to the buyer based on the terms of the contract. If approved, the issuing bank provides a L/C (also referred to as a Documentary Credit (“D/C”)). The bank issues the letter of credit based on the line of credit, and the letter of credit indicates that the letter of credit cannot exceed the amount of the line of credit.

As shown in FIG. 7, the issuing bank assists the buyer by facilitating the transaction (based on the terms of the contract) and ensuring the buyer receives the purchased goods/services before paying funds to the seller. The issuing bank has an agreement with the advising bank to transfer funds at the appropriate time. The advising bank may also be referred to as a confirming bank or a negotiating bank. In some embodiments, the issuing bank is located in the same country as the buyer and the advising bank is located in the same country as the seller. In some situations, the issuing bank may notify the seller that the transaction will be facilitated by the issuing bank and notifies the seller that they will receive payment from the advising bank. The issuing bank then sends the contract, L/C, D/C, and any other supporting documents or information associated with the transaction to the advising bank (step #3 in FIG. 7). Thus, the advising bank has access to all details and information associated with the transaction.

In some embodiments, the issuing bank defines the specific activities, events, and conditions that are necessary for the issuing bank to release funds to the advising bank (for payment to the seller). For example, specific approvals, verifications, and other confirmations may be required before the issuing bank will release funds to the advising bank. At step “4”, the advising bank sends the contract, L/C, D/C, and any other supporting documents or information associated with the transaction to the seller. When all of the documents are completed, the seller ships the goods to the buyer (step #5 in FIG. 7). The shipping is defined by the terms of the contract, which may describe shipping locations, which party pays for insurance at different phases of the shipment, where the goods are shipping from, where the goods are to be received, how they are to be transported, which transport company is used at different phases of shipment, and the like. In some instances, the contract also describes which party has liability for the goods at different points in the process. For example, the seller initially has possession of the goods and has liability for the goods at that time. The contract will specify that, at some point during the shipping process, the liability for the goods moves to the buyer. This liability for the goods may move when the goods are delivered by the seller to a shipping company, when the goods are received at the destination, or any other point during the shipping/transportation process.

When the goods are delivered to the destination, the buyer does not receive the documents to take possession of the goods. Instead, the remainder of the trade finance process must be completed before buyer receives the documents that allow the buyer to take possession of the goods. This ensures that the seller gets paid before the documents are given to the buyer and the goods are released to the buyer.

After the seller has shipped the goods, the seller provides all shipping documents and other information associated with the shipped goods to the advising bank (step #6 in FIG. 7). The seller may also notify the buyer that the goods have been shipped. The advising bank then confirms the shipping documents (and other information associated with the shipped goods) are in compliance with the terms of the contract as well as the L/C and D/C received from the issuing bank. If anything is missing or incorrect in the shipping documents (and other information) received by the advising bank, then the advising bank contacts the seller (step #7 in FIG. 7) and requests the missing information or requests correction of the improper/incorrect shipping documents or other information. For example, the documents received from the seller may be missing a signature or proper verification of the seller or another party (e.g., a shipping agent, transportation agent, or port agent) on one or more documents. In some situations, one or more documents may not be fully completed and are missing one or more items of information required in the documentation. The advising bank continues to communicate with the seller until all documents are complete and appropriately signed or verified. This is an objective process as defined in the original contract as well as the L/C and D/C requirements. If the advising bank does not ensure that all documents and other information is fully complete, the issuing bank may refuse to release payment funds to the advising bank.

After the documents are completed, the advising bank sends the completed documents (and any other information) to the issuing bank (step #8 in FIG. 7). The issuing bank then performs its own analysis and verification of the documents and any other information received from the advising bank. If the issuing bank verifies the documents and other information, it sends the payment to the advising bank (step #9 in FIG. 7). In some embodiments, the payment is sent to the advising bank in a currency associated with the issuing bank, a currency associated with the advising bank, or some other currency.

After the issuing bank sends payment to the advising bank, the issuing bank releases (e.g., sends) the documents to the buyer (step #10 in FIG. 7). The buyer uses the received documents to take delivery of the goods (step #11 in FIG. 7). In some embodiments, the issuing bank may require payment from the buyer (or require other information, agreements, or verifications) before the issuing bank releases the documents to the buyer.

In some embodiments, a reimbursing bank handles payment from the issuing bank to the advising bank. In this situation, the reimbursing bank receives reimbursement authorization from the issuing bank, which may include the contract, L/C, and DC documents (step 3A in FIG. 7). After all documents are approved and verified by the issuing bank, the issuing bank sends payment to the reimbursing bank instead of the advising bank. The reimbursing bank then sends the payment to the advising bank (step 9A in FIG. 7). In some embodiments, the reimbursing bank receives payment from the issuing bank in a first currency and sends the payment to the advising bank in a second currency.

As discussed herein, the process shown in FIG. 7 includes significant manual operations, such as obtaining signatures on individual documents, monitoring which documents have been signed, reminding individuals to sign or fill-in documents, and the like. Additionally, many of the documents (e.g., the contract, L/C, and D/C) are paper documents that must be physically transported between different parties to fill-in the documents, receive signatures, and the like. This approach to trade finance is inefficient and requires significant human interaction to process all of the necessary steps.

The systems and methods discussed herein provide an improved process for handling these types of transactions, as well as other types of transactions. In some embodiments, the systems and methods provide automated approval and verification of the documents associated with a particular transaction. As mentioned above, the approval and verification process may include multiple individuals and multiple entities. For example, certain documents may be approved using an electronic signing and approval service such as DocuSign, Adobe Sign, and the like. For example, a Letter of Credit may include multiple locations that require signature and/or authorization. These document locations may be signed electronically by an appropriate person using an electronic signature, video evidence, and the like. The systems and methods described herein manage and facilitate the automatic collection of signatures, authorizations, confirmations, and other information necessary to complete the trade finance process. For example, the described systems and methods may instruct a particular person to fill out specific portions of the document and sign or provide video evidence (e.g., a picture of a driver's license, a picture of a shipping receipt, a recorded video, etc.) at one or more locations within the document. The signature or video evidence can be provided by a person using any type of computing device, such as a mobile device, a tablet computer, a laptop computer, a desktop computer, a portable scanning device, and the like. After the person has completed the specific portions of the document, the systems and methods can verify that the person properly completed all necessary portions of the document. If any portion was not completed properly, the systems and methods instruct the person to complete the missing portions. When the document is completed, a notification may be sent to one or more parties or entities indicating that the document is completed. The completed document may be stored in a common data store for reference by other parties or entities (e.g., banks) involved in the transaction.

In some embodiments, a workflow defines the overall trade finance process (e.g., some or all of the steps in FIG. 7) and the activities that need to happen at each point in the workflow. The progress of the workflow is tracked by the systems and methods discussed herein. The progress of the workflow represents the progress of the documentation associated with the transaction. By tracking the progress of the workflow and each of the documents involved in the workflow, the described systems and methods are able to automate the overall handling of the trade finance process. In some embodiments, the workflow is defined based on the original contract between the parties to the transaction (e.g., the buyer and the seller).

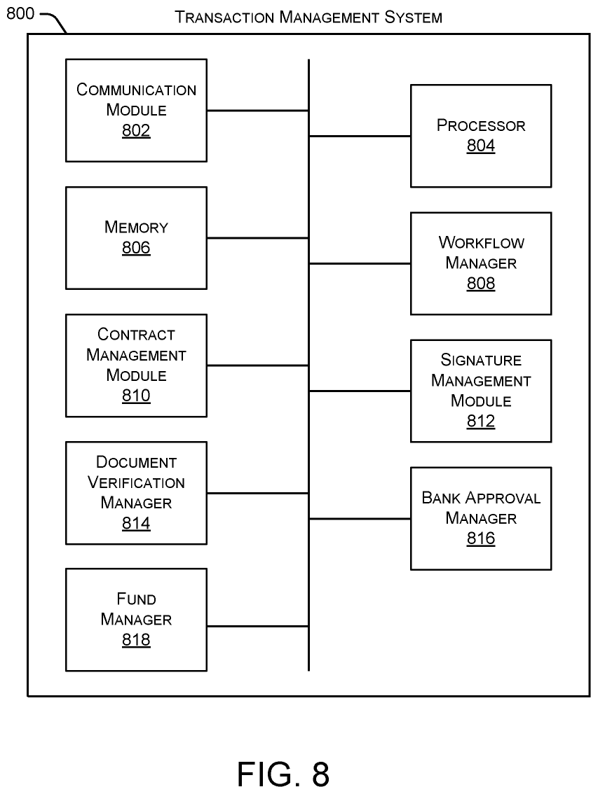

FIG. 8 is a block diagram illustrating an embodiment of a transaction management system 800. In some embodiments, transaction management system 800 is coupled to financial management system 102 or any other financial management or financial transaction processing system. In particular implementations, transaction management system 800 is integrated into financial management system 102. In some embodiments, transaction management system 800 can access data store 116 and ledger 118 discussed herein. In certain situations, transaction management system 800 may interact with trade finance module 232.

As shown in FIG. 8, transaction management system 800 includes a communication module 802, a processor 804, and a memory 806. Communication module 802 allows transaction management system 800 to communicate with other systems and devices. Processor 804 executes various instructions to implement the functionality provided by transaction management system 800, as discussed herein. Memory 806 stores these instructions as well as other data used by processor 804 and other modules and components discussed herein.

A workflow manager 808 manages the definition and execution of one or more workflows associated with one or more transactions. A contract management module 810 manages the creation and execution of contracts associated with one or more transactions. Contract management module 810 may also monitor a workflow status as it relates to the terms of a particular contract. A signature management module 812 manages the collection of signatures, video evidence, and other information required in various documents. A document verification manager 814 monitors multiple documents and determines whether each document has been property verified. A bank approval manager 816 determines whether a particular bank has approved its portion of a transaction. Finally, a fund manager 818 monitors the transfer of funds between financial institutions and/or between a financial institution and an individual.

The systems and methods described herein are also capable of facilitating a transaction across multiple countries. Typically, banking systems in one country differ from banking systems in another country. For example, two heterogeneous banking systems (referred to as HKTFP (Hong Kong Trade Finance Platform) and NTP) may want to communicate and interact with one another to facilitate a transaction defined by a particular contract. Each banking system has its own users and entities, such as banks, buyers, sellers, shippers, insurance agents, and the like. In transactions that involve users or entities in multiple banking systems, the users and entities in one banking system need to know about the users and entities in the other banking system. For example, a buyer in the HKTFP banking system needs to know about a seller in the NTP banking system. Each banking system has a system directory that identifies all users and entities in the particular banking system. The novel systems and methods discussed herein integrate with and synchronize the system directories of the two banking systems, which helps facilitate the transaction. In some embodiments, this is accomplished by having the systems and methods described herein integrate with both the HKTFP and NTP banking systems (e.g., using the clearing and settlement gateway and other components/systems discussed herein (see, for example, FIG. 2)). Each time a new user or entity is added to either banking system, the systems and methods described herein receive notification of the new user/entity and export that new user/entity into a global directory and assigns a unique identifier to the new user/entity. The described systems and methods also create and maintain a mapping between the unique identifier assigned to the new user/entity and the local identifier associated with the user/entity in their local banking system (e.g., HKTFP or NTP). For example a user in HKTFP may have a local identifier as RogerSmith and that same user has a unique identifier assigned by the described systems and methods as HKRogerSmith. Thus, the existing local banking systems can continue to operate using the same existing local identifiers. In some embodiments, the systems and methods described herein help implement and facilitate a connectivity network between the two banking systems. The described systems and methods also update information associated with each user/entity (e.g., delete user/entity or change user/entity data) in response to local changes to the user/entity in their local banking system.

In a particular example, a buyer in Hong Kong enters into a contract for the sale of goods with a seller in Singapore. Hong Kong documents related to the contract reside in the Hong Kong banking system and Singapore documents related to the contract reside in the Singapore banking system. The systems and methods described herein facilitate the transfer of documents and information between the Hong Kong banking system and the Singapore banking system. In some embodiments, the systems and methods also facilitate (or help coordinate) obtaining signatures and/or verifications of the various documents associated with the contract. The systems and methods discussed herein provide APIs (Application Program Interfaces) that allow the Hong Kong banking system and the Singapore banking system to communicate and interact with the described systems and methods. Thus, the Hong Kong banking system and the Singapore banking system continue to operate in their normal manner. The described systems and methods receive requests from the Hong Kong banking system and the Singapore banking system and provides documents and other information to the Hong Kong and Singapore banking systems without requiring those banking systems to change their manner of operation. Thus, the Hong Kong and Singapore banking systems can continue using the same data formats and other processes that they are already accustomed to using. As the workflow associated with the contract is processed, the described systems and methods monitor the workflow and the status of each document. The workflow status and the status of each document is available to all parties (e.g., the buyer, the seller, the Hong Kong banking system, and the Singapore banking system) in substantially real time via the systems and methods described herein.

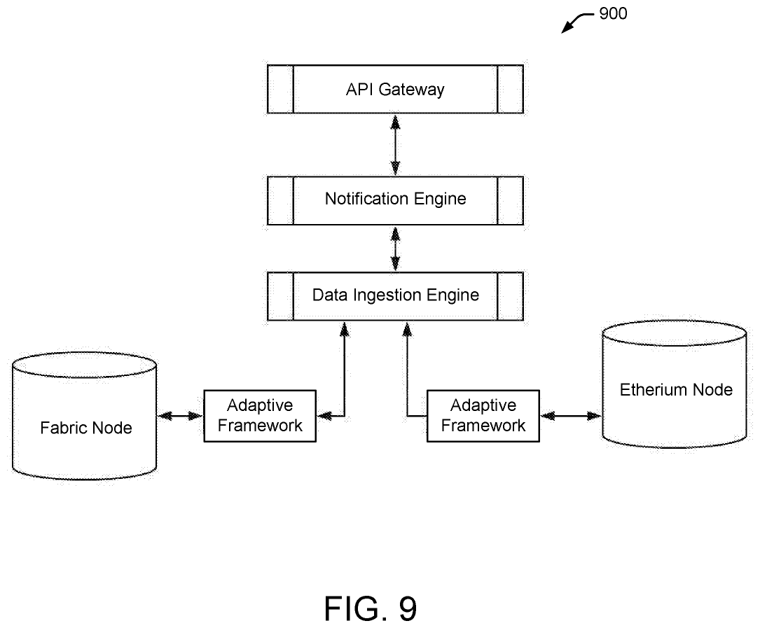

FIG. 9 is a block diagram illustrating an example architecture 900 for coordinating a workflow across multiple systems. As discussed above, multiple parties to a transaction (or contract) may perform different tasks in the workflow. In some embodiments, the workflow understands the various documents associated with a transaction (or contract) and the relationships between the various documents. Additionally, the workflow understands the structure of the documents and the taxonomy relationships and/or the ontology relationships between the documents and portions of the documents, as discussed herein.

As shown in FIG. 9, adaptive frameworks communicate between various nodes and a data ingestion engine associated with the systems and methods discussed herein. The adaptive frameworks support collaboration between the multiple parties. Additionally, the data ingestion engine, and other elements shown in FIG. 9, help coordinate workflow activities associated with different parties to the transaction (or contract). The Fabric Node in FIG. 9 is a hyperledger, which is a type of blockchain, and the Etherium Node is another type of blockchain. Any changes made to users associated with the Fabric Node or the Etherium Node are communicated to the data ingestion engine so those users can also be updated in a global directory maintained the systems and methods discussed herein. Those changes may also be communicated to a notification engine for processing. For example, if a new user is added to the Etherium Node, a global identifier is created and stored in the global directory. That global identifier associated with the new user is communicated to the Fabric Node so that node learns of the new user. Thus, for the new user, the Fabric Node uses the new nomenclature (e.g., global identifier) generated by the systems and methods described herein. In some embodiments, the system also creates an alias for the new user in addition to the new user's global identifier. However, the alias may not be unique.

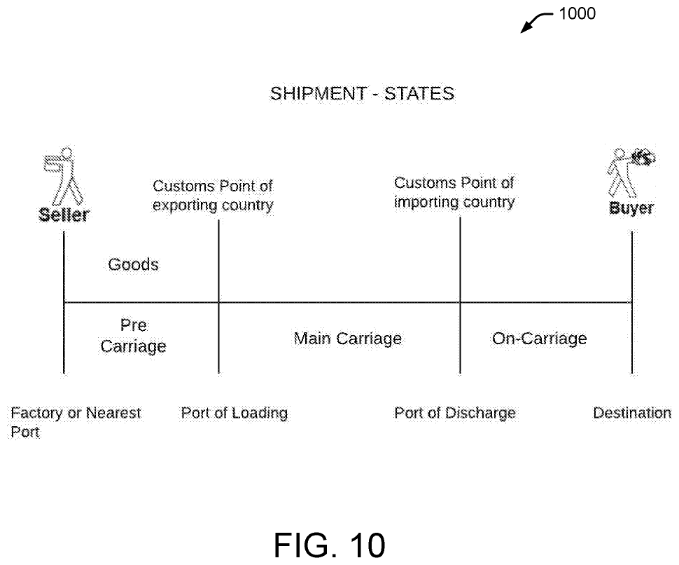

FIG. 10 is a block diagram illustrating an example of different states 1000 of a shipping process. Various documents are used at different states of the shipping process. In some embodiments, the contract specifies which shippers or other entities are approved for use during shipment of the goods associated with the contract. In particular implementations, a unique serial number is associated with each shipment. This unique serial number is used on all documents and used during all states of the shipping process, thereby providing a consistent way of tracking all aspects (and all documents) of a particular shipment. Thus, the systems and methods are able to track the particular shipment, track the status of all documents associated with the shipment, and track the status of the workflow associated with the shipment during a trade finance process. In some embodiments, the systems and methods communicate with the various shipping companies, insurance companies, and the like to maintain an up-to-date status of the shipment.

In some embodiments, different contracts may specify (or allow) different entities, such as shipping companies, insurance companies, and the like. The workflow used to manage execution of a contract may be normalized such that the same workflow is used for different shipping companies, insurance companies, etc. For example, a workflow term “delivered” has the same meaning regardless of which shipping company is used to ship and/or deliver the goods associated with a particular transaction.

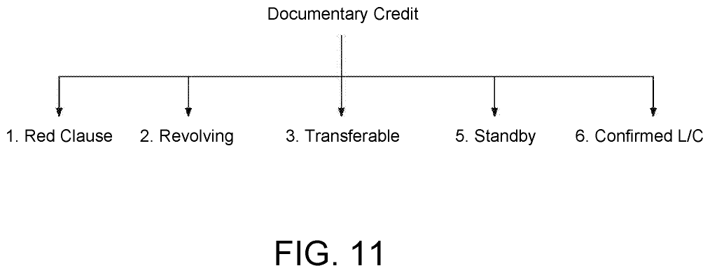

FIG. 11 illustrates different types of documentary credit, such as the types of credit that may be opened by a buyer. Different activities may be necessary based on the type of credit opened by the buyer.

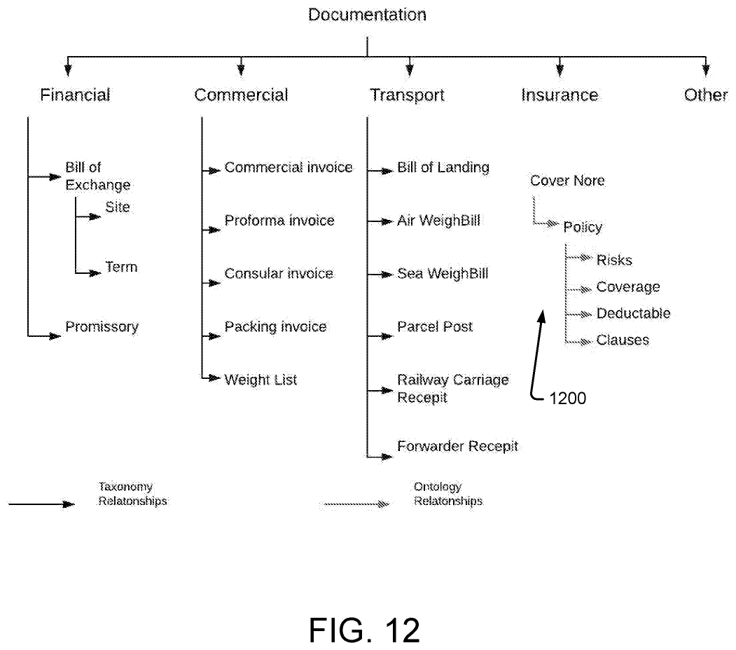

FIG. 12 illustrates the taxonomy relationships and ontology relationships between different portions of multiple types of documents. All of the relationships shown in FIG. 12 are taxonomy relationships, except the Policy relationships 1200 (Risks, Coverage, Deductible, and Clauses) on the right side of FIG. 12. A taxonomy relationship is a hierarchical relationship and an ontology relationship is network relationship (no hierarchy). The workflows discussed herein are capable of understanding both hierarchical structures (and hierarchical relationships) and network structures (and network relationships). The structure and relationships of the documents are reflected in the workflow. Thus, at any point in the workflow, the workflow defines the next step or activity to perform in each of the documents.

The systems and methods described herein may use a tiered architecture that can scale up to requests for clearing and settlement. The architecture provides for an auto scaled architecture where micro services such as clearing services can scale up or shrink depending on the requests to the architecture.

The described systems and methods maintain a history of all transactions within the network. In some embodiments, the systems and methods provide a query interface for participants to search for parts of the ledger. Additionally, the systems and methods have a subscription based interface for the participants to subscribe to changes in the network in real time (or substantially real time). The following are important aspects of the ledger: transaction states, securing the ledger entries, querying and subscribing to the ledger, and ledger replication.

Transaction states are initiated on the request of the participants or when a trigger-based clearing or settlement is set by the participants. A transaction has various states that it passes through from the initial state to the terminal state. The transaction and the associated states have additional metadata. The ledger records all of the state changes for a transaction. For each transaction, multiple records are stored to show the state changes. In some embodiments, this record is not updated. By default, all transactions are final and irreversible. Some transactions may have been created in error (“fat finger”). For such transaction to be reversed, a new transaction is initiated. The metadata for the new transaction includes a reference to the transaction that needs to be reversed. The parties are informed on the request to reverse the transaction as part of a new transaction. The new transaction also goes through the state changes discussed herein. When completed, the metadata of the initial transaction is also updated (making that mutable for this scenario).

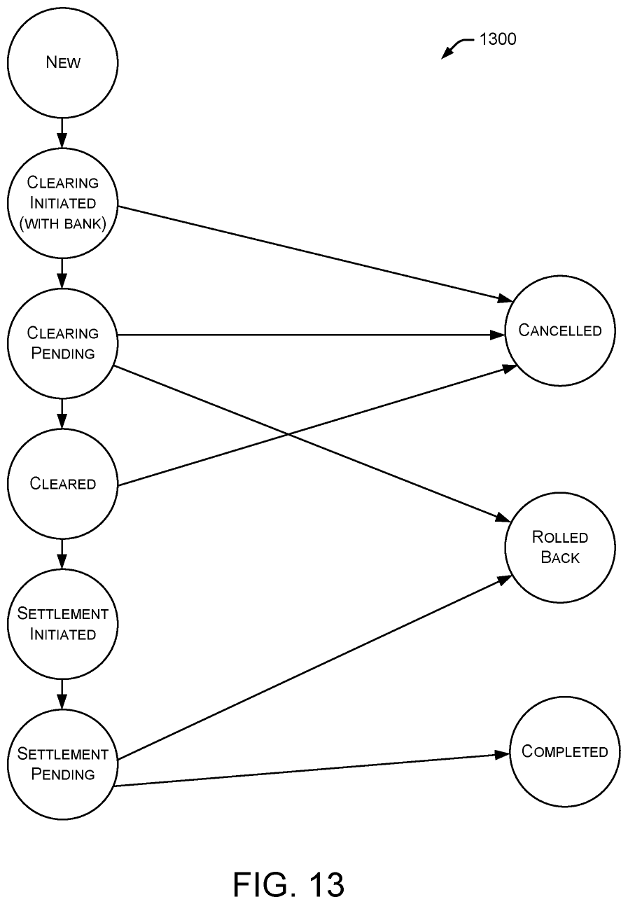

FIG. 13 illustrates an example state diagram 1300 showing various states that a transaction may pass through. As shown in FIG. 13, a particular transaction may be initiated (“new”), then clearing is initiated with a bank, after which the transaction's state is “clearing pending.” The next transaction state is “cleared”, then settlement is initiated, after which the transaction state is “settlement pending.” After the transaction has settled, the state becomes “completed.” As shown in state diagram 1300, the state diagram may branch to “cancelled” at locations in the state diagram. For example, a transaction may be cancelled due to insufficient funds, a mutual decision to reverse the transaction before settlement, a bank internal ledger failure, and the like. Additionally, the state diagram may branch to “rolled back” at multiple locations. For example, a transaction may be rolled back due to an unrecoverable error, a cancellation of the transaction, and the like.

Each transaction and the associated transaction states may have additional metadata. The shared ledger (e.g., ledger 118 in FIG. 1) man contain all the state information and state changes for a transaction. A separate record is maintained for each state of the transaction. The record is not updated or modified. In some embodiments, all transactions are final and irreversible. The metadata for the new transaction includes a reference to the erroneous transaction that needs to be reversed. The parties are informed of the request to reverse the erroneous transaction as part of a new transaction. The new transaction also goes through the state changes shown in FIG. 13. When the new transaction is completed, the metadata of the initial transaction is also updated.

In some embodiments, the transactions and the metadata recorded in the shared permissioned ledger contain information that are very sensitive and confidential to the businesses initiating the instructions. The systems and methods described herein maintain the security of this information by encrypting data for each participant using a symmetric key that is unique to the participant. In some embodiments, the keys also have a key rotation policy where the data for that node is rekeyed. The keys for each node are bifurcated and saved in a secure storage location with role-based access controls. In some embodiments, only a special service called a cryptographic service can access these keys at runtime to encrypt and decrypt the data.

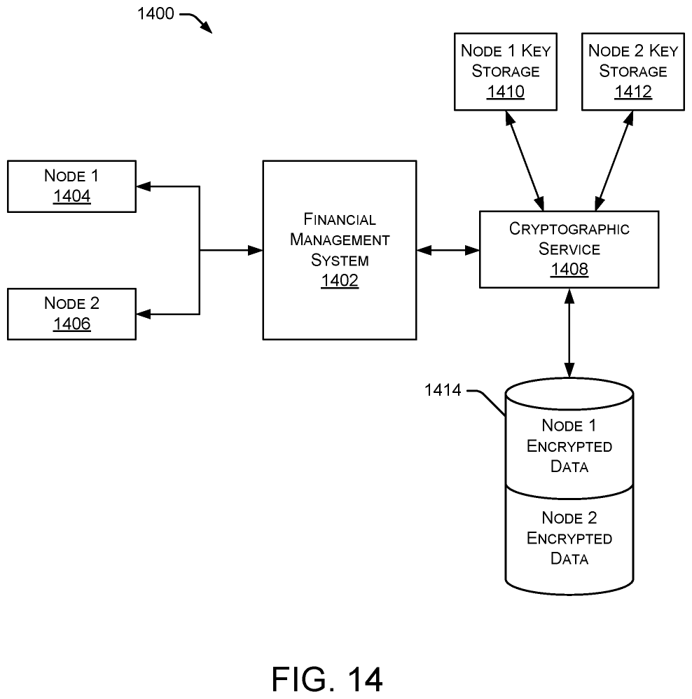

FIG. 14 is a block diagram illustrating an embodiment 1400 of a financial management system 1402 interacting with a cryptographic service 1408 and multiple client nodes 1404 and 1406. Although two client nodes 1404, 1406 are shown in FIG. 14, alternate embodiments may include any number of client nodes coupled to financial management system 1402. In the embodiment of FIG. 14, financial management system 1402 communicates with client nodes 1404, 1406 to manage one or more transactions between client nodes 1404 and 1406, or between one of client nodes 1404, 1406 and other client nodes, devices, or systems (not shown). Financial management system 1402 also communicates with cryptographic service 1408, which manages secure access to a data store 1414. In some embodiments, data store 1414 is a shared ledger (e.g., ledger 118 in FIG. 1) of the type discussed herein. In these embodiments, data store 1414 represents the capabilities of the shared ledger as they relate to data permissions.

As shown in FIG. 14, data store 1414 stores encrypted data associated with client nodes 1404 and 1406. In alternate embodiments, data store 1414 may store encrypted data associated with any number of client nodes. Cryptographic service 1408 ensures security of the data in data store 1414 using, for example, secure bifurcated keys that are stored in node 1 key storage 1410 and node 2 key storage 1412. Each key is unique for the associated client node. When financial management system 1402 wants to access data from data store 1414, the data access request must include an appropriate key to ensure that the data access request is authorized.

Each transaction can have two or more participants. In addition to the multiple parties involved in the transaction, there can be one or more “observers” to the transaction. The observer status is important from a compliance and governance standpoint. For example, the Federal Reserve or the CFTC is not a participant of the transaction, but may have observer rights on certain type of transactions in the system. In some embodiments the participants can subscribe to certain types of events. The transaction state in the state diagram above changes trigger events in the described systems.

FIG. 15 is a block diagram illustrating an example computing device 1500. Computing device 1500 may be used to perform various procedures, such as those discussed herein. Computing device 1500 can function as a server, a client, a client node, a financial management system, or any other computing entity. Computing device 1500 can be any of a wide variety of computing devices, such as a workstation, a desktop computer, a notebook computer, a server computer, a handheld computer, a tablet, a smartphone, and the like. In some embodiments, computing device 1500 represents any of the computing devices discussed herein.

Computing device 1500 includes one or more processor(s) 1502, one or more memory device(s) 1504, one or more interface(s) 1506, one or more mass storage device(s) 1508, and one or more Input/Output (I/O) device(s) 1510, all of which are coupled to a bus 1512. Processor(s) 1502 include one or more processors or controllers that execute instructions stored in memory device(s) 1504 and/or mass storage device(s) 1508. Processor(s) 1502 may also include various types of computer-readable media, such as cache memory.

Memory device(s) 1504 include various computer-readable media, such as volatile memory (e.g., random access memory (RAM)) and/or nonvolatile memory (e.g., read-only memory (ROM)). Memory device(s) 1504 may also include rewritable ROM, such as Flash memory.

Mass storage device(s) 1508 include various computer readable media, such as magnetic tapes, magnetic disks, optical disks, solid state memory (e.g., Flash memory), and so forth. Various drives may also be included in mass storage device(s) 1508 to enable reading from and/or writing to the various computer readable media. Mass storage device(s) 1508 include removable media and/or non-removable media.

I/O device(s) 1510 include various devices that allow data and/or other information to be input to or retrieved from computing device 1500. Example I/O device(s) 1510 include cursor control devices, keyboards, keypads, microphones, monitors or other display devices, speakers, printers, network interface cards, modems, lenses, CCDs or other image capture devices, and the like.

Interface(s) 1506 include various interfaces that allow computing device 1500 to interact with other systems, devices, or computing environments. Example interface(s) 1506 include any number of different network interfaces, such as interfaces to local area networks (LANs), wide area networks (WANs), wireless networks, and the Internet.

Bus 1512 allows processor(s) 1502, memory device(s) 1504, interface(s) 1506, mass storage device(s) 1508, and I/O device(s) 1510 to communicate with one another, as well as other devices or components coupled to bus 1512. Bus 1512 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1500, and are executed by processor(s) 1502. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” “selected embodiments,” “certain embodiments,” etc., indicate that the embodiment or embodiments described may include a particular feature, structure, or characteristic, but every embodiment may not necessarily include the particular feature, structure, or characteristic. Additionally, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that may be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can include at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired and wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions include, for example, instructions and data which, when executed at a processor, cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a module may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments, but should be defined only in accordance with the following claims and their equivalents. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A method comprising:
receiving, by a transaction management system, information associated with a trade transaction between at least one seller and at least one buyer;
defining, by the transaction management system, at least one workflow to execute the trade transaction;
creating, by the transaction management system, at least one contract associated with the trade transaction;
collecting, by the transaction management system, at least one of signatures or video evidence that the at least one seller and at least one buyer confirm the at least one contract associated with the trade transaction; and
verifying, by the transaction management system, the at least one contract.

2. The method of claim 1, further comprising determining whether at least one bank associated with the trade transaction approved its portion of the transaction.

3. The method of claim 1, further comprising determining whether:
a first bank associated with the seller approved its portion of the transaction; and
a second bank associated with the buyer approved its portion of the transaction.

4. The method of claim 3, wherein the first bank is located in a first country and the second bank is located in a second country.

5. The method of claim 4, wherein the first bank has an associated first system directory that identifies users in the first bank's banking system, wherein the second bank has an associated second system directory that identifies users in the second bank's banking system, and wherein the transaction management system is further configured to integrate and synchronize the first system directory and the second system directory.

6. The method of claim 1, further comprising monitoring a transfer of funds between banks associated with at least a portion of the trade transaction.

7. The method of claim 1, wherein the seller is located in a first country and the buyer is located in a second country.

8. The method of claim 1, further comprising providing access to a permissioned ledger by a first bank associated with the seller and a second bank associated with the buyer.

9. The method of claim 8, wherein the seller only has access to data associated with the seller's portion of the trade transaction and the buyer only has access to data associated with the buyer's portion of the trade transaction.

10. The method of claim 1, further comprising communicating collaborative data between parties associated with the trade transaction.

11. The method of claim 10, wherein the parties associated with the trade transaction include at least one of the seller, the buyer, a bank associated with the seller, and a bank associated with the buyer.

12. The method of claim 1, further comprising associating a unique serial number with all documents associated with the trade transaction.

13. The method of claim 1, wherein the transaction management system can track all activities associated with the trade transaction based on the unique serial number.

14. An apparatus comprising:
a communication module configured to receive information associated with a trade transaction between a seller and a buyer;
a workflow manager configured to define at least one workflow to execute the trade transaction;
a contract management module configured to create at least one contract associated with the trade transaction;
a signature management module configured to collect at least one of signatures or video evidence that the seller and the buyer confirm the at least one contract associated with the trade transaction; and
a document verification manager configured to verify the at least one contract.

15. The apparatus of claim 14, further comprising a bank approval manager configured to determine whether at least one bank associated with the trade transaction approved its portion of the transaction.

16. The apparatus of claim 14, further comprising a bank approval manager configured to determine whether a first bank associated with the seller approved its portion of the transaction, and a second bank associated with the buyer approved its portion of the transaction.

17. The apparatus of claim 16, wherein the first bank is located in a first country and the second bank is located in a second country.

18. The apparatus of claim 14, further comprising a fund manager configured to monitor a transfer of funds between banks associated with at least a portion of the trade transaction.

19. The apparatus of claim 14, wherein the apparatus is a transaction management system.

20. The apparatus of claim 14, further comprising a communication module configured to communicate collaborative data between parties associated with the trade transaction.
